(19) United States
(12) Patent Application Publication
(10) Pub. No.: US 2026/0319640 A1
(43) Pub. Date: Oct. 15, 2026

(54) TECHNIQUES FOR DISPLAYING LIVE ACTIVITIES

(71) Applicant: Apple Inc., Cupertino, CA (US)

(72) Inventors: Chance R. DANIEL, San Francisco, CA (US); Matthew H. GAMBLE, Mill Valley, CA (US); Nathan A. WOOD, Sunnyvale, CA (US)

(21) Appl. No.: 19/262,686

(22) Filed: Jul. 8, 2025

Related U.S. Application Data
(60) Provisional application No. 63/787,210, filed on Apr. 11, 2025.

(51) Int. Cl. G06F 3/0484; G06F 3/0481; G06V 20/50; G06V 40/10

(52) U.S. Cl. CPC G06F 3/0484; G06F 3/0481; G06V 20/50; G06V 40/10

(57) ABSTRACT

The present disclosure generally relates to displaying live activities. Some techniques are for displaying content of an application based on state of device in accordance with some embodiments. Other techniques are for performing an operation based on a subject in accordance with some embodiments.

### CROSS-REFERENCE TO RELATED APPLICATIONS

The present patent application claims priority to U. S Provisional Patent Application Ser. No. 63/787,210, entitled “TECHNIQUES FOR DISPLAYING LIVE ACTIVITIES” filed Apr. 11, 2025, which is hereby incorporated by reference in its entirety for all purposes.

### BACKGROUND

Electronic devices are becoming more communal in nature allowing multiple users to access specialized applications. Different users often access personalized and/or private data from communal electronic devices. For example, devices are able to display live activities (e.g., sports scores, news updates, and/or weather conditions) that are tailored to a specific user's preferences.

### SUMMARY

Some techniques for displaying live activities are generally ineffective and/or inefficient. For example, some techniques require users to manually log in and authenticate themselves each time they want to access their own content. This disclosure provides more effective and/or efficient techniques for displaying content without the user having to manually authenticate themselves. In addition, techniques optionally complement or replace other techniques for displaying content.

Accordingly, the present technique allows devices to display personalized content (e.g., live activities) in a particular style (e.g., an orientation, a size, and/or a color scheme) based on a current state of the devices. Other techniques are described herein to allow a device to perform different operations based on an identified user interacting with the device.

In some embodiments, a method that is performed at a device, by a system process, that is in communication with one or more display generation components is described. In some embodiments, the method comprises: receiving, from an application of the device, a definition of a user interface region managed by the system process, wherein the definition includes definition of multiple user interface elements to be displayed within the user interface region; after receiving the definition of the user interface region managed by the system process of the device, receiving a request to display a respective user interface element of the multiple user interface elements; in response to receiving the request to display the respective user interface element of the multiple user interface elements: in accordance with a determination that the request corresponds to a first user interface element, displaying, via the one or more display generation components, the first user interface element based on a current state of the device; and in accordance with a determination that the request corresponds to a second user interface element, displaying, via the one or more display generation components, the second user interface element based on the current state of the device, wherein the second user interface element is different from the first user interface element.

In some embodiments, a non-transitory computer-readable storage medium storing one or more programs configured to be executed by one or more processors of a device, by a system process, that is in communication with one or more display generation components is described. In some embodiments, the one or more programs includes instructions for: receiving, from an application of the device, a definition of a user interface region managed by the system process, wherein the definition includes definition of multiple user interface elements to be displayed within the user interface region; after receiving the definition of the user interface region managed by the system process of the device, receiving a request to display a respective user interface element of the multiple user interface elements; in response to receiving the request to display the respective user interface element of the multiple user interface elements: in accordance with a determination that the request corresponds to a first user interface element, displaying, via the one or more display generation components, the first user interface element based on a current state of the device; and in accordance with a determination that the request corresponds to a second user interface element, displaying, via the one or more display generation components, the second user interface element based on the current state of the device, wherein the second user interface element is different from the first user interface element.

In some embodiments, a transitory computer-readable storage medium storing one or more programs configured to be executed by one or more processors of a device, by a system process, that is in communication with one or more display generation components is described. In some embodiments, the one or more programs includes instructions for: receiving, from an application of the device, a definition of a user interface region managed by the system process, wherein the definition includes definition of multiple user interface elements to be displayed within the user interface region; after receiving the definition of the user interface region managed by the system process of the device, receiving a request to display a respective user interface element of the multiple user interface elements; in response to receiving the request to display the respective user interface element of the multiple user interface elements: in accordance with a determination that the request corresponds to a first user interface element, displaying, via the one or more display generation components, the first user interface element based on a current state of the device; and in accordance with a determination that the request corresponds to a second user interface element, displaying, via the one or more display generation components, the second user interface element based on the current state of the device, wherein the second user interface element is different from the first user interface element.

In some embodiments, a device, by a system process, configured to communicate with one or more display generation components is described. In some embodiments, the device comprises one or more processors and memory storing one or more programs configured to be executed by the one or more processors. In some embodiments, the one or more programs includes instructions for: receiving, from an application of the device, a definition of a user interface region managed by the system process, wherein the definition includes definition of multiple user interface elements to be displayed within the user interface region; after receiving the definition of the user interface region managed by the system process of the device, receiving a request to display a respective user interface element of the multiple user interface elements; in response to receiving the request to display the respective user interface element of the multiple user interface elements: in accordance with a determination that the request corresponds to a first user interface element, displaying, via the one or more display generation components, the first user interface element based on a current state of the device; and in accordance with a determination that the request corresponds to a second user interface element, displaying, via the one or more display generation components, the second user interface element based on the current state of the device, wherein the second user interface element is different from the first user interface element.

In some embodiments, a device, by a system process, configured to communicate with one or more display generation components is described. In some embodiments, the device comprises means for performing each of the following steps: receiving, from an application of the device, a definition of a user interface region managed by the system process, wherein the definition includes definition of multiple user interface elements to be displayed within the user interface region; after receiving the definition of the user interface region managed by the system process of the device, receiving a request to display a respective user interface element of the multiple user interface elements; in response to receiving the request to display the respective user interface element of the multiple user interface elements: in accordance with a determination that the request corresponds to a first user interface element, displaying, via the one or more display generation components, the first user interface element based on a current state of the device; and in accordance with a determination that the request corresponds to a second user interface element, displaying, via the one or more display generation components, the second user interface element based on the current state of the device, wherein the second user interface element is different from the first user interface element.

In some embodiments, a computer program product is described. In some embodiments, the computer program product comprises one or more programs configured to be executed by one or more processors of a device, by a system process, that is in communication with one or more display generation components. In some embodiments, the one or more programs include instructions for: receiving, from an application of the device, a definition of a user interface region managed by the system process, wherein the definition includes definition of multiple user interface elements to be displayed within the user interface region; after receiving the definition of the user interface region managed by the system process of the device, receiving a request to display a respective user interface element of the multiple user interface elements; in response to receiving the request to display the respective user interface element of the multiple user interface elements: in accordance with a determination that the request corresponds to a first user interface element, displaying, via the one or more display generation components, the first user interface element based on a current state of the device; and in accordance with a determination that the request corresponds to a second user interface element, displaying, via the one or more display generation components, the second user interface element based on the current state of the device, wherein the second user interface element is different from the first user interface element.

In some embodiments, a method that is performed at a device, by an application, that is in communication with one or more display generation components is described. In some embodiments, the method comprises: while a user interface element is being displayed via the one or more display generation components: receiving an input corresponding to the user interface element; and in response to receiving the input corresponding to the user interface element: in accordance with a determination that the input corresponds to a first subject, performing a first operation corresponding to the first subject; and in accordance with a determination that the input corresponds to a second subject, performing a second operation, different from the first operation, corresponding to the second subject, wherein the second subject is different from the first subject.

In some embodiments, a non-transitory computer-readable storage medium storing one or more programs configured to be executed by one or more processors of a device, by an application, that is in communication with one or more display generation components is described. In some embodiments, the one or more programs includes instructions for: while a user interface element is being displayed via the one or more display generation components: receiving an input corresponding to the user interface element; and in response to receiving the input corresponding to the user interface element: in accordance with a determination that the input corresponds to a first subject, performing a first operation corresponding to the first subject; and in accordance with a determination that the input corresponds to a second subject, performing a second operation, different from the first operation, corresponding to the second subject, wherein the second subject is different from the first subject.

In some embodiments, a transitory computer-readable storage medium storing one or more programs configured to be executed by one or more processors of a device, by an application, that is in communication with one or more display generation components is described. In some embodiments, the one or more programs includes instructions for: while a user interface element is being displayed via the one or more display generation components: receiving an input corresponding to the user interface element; and in response to receiving the input corresponding to the user interface element: in accordance with a determination that the input corresponds to a first subject, performing a first operation corresponding to the first subject; and in accordance with a determination that the input corresponds to a second subject, performing a second operation, different from the first operation, corresponding to the second subject, wherein the second subject is different from the first subject.

In some embodiments, a device, by an application, configured to communicate with one or more display generation components is described. In some embodiments, the device comprises one or more processors and memory storing one or more programs configured to be executed by the one or more processors. In some embodiments, the one or more programs includes instructions for: while a user interface element is being displayed via the one or more display generation components: receiving an input corresponding to the user interface element; and in response to receiving the input corresponding to the user interface element: in accordance with a determination that the input corresponds to a first subject, performing a first operation corresponding to the first subject; and in accordance with a determination that the input corresponds to a second subject, performing a second operation, different from the first operation, corresponding to the second subject, wherein the second subject is different from the first subject.

In some embodiments, a device, by an application, configured to communicate with one or more display generation components is described. In some embodiments, the device comprises means for performing each of the following steps: while a user interface element is being displayed via the one or more display generation components: receiving an input corresponding to the user interface element; and in response to receiving the input corresponding to the user interface element: in accordance with a determination that the input corresponds to a first subject, performing a first operation corresponding to the first subject; and in accordance with a determination that the input corresponds to a second subject, performing a second operation, different from the first operation, corresponding to the second subject, wherein the second subject is different from the first subject.

In some embodiments, a computer program product is described. In some embodiments, the computer program product comprises one or more programs configured to be executed by one or more processors of a device, by an application, that is in communication with one or more display generation components. In some embodiments, the one or more programs include instructions for: while a user interface element is being displayed via the one or more display generation components: receiving an input corresponding to the user interface element; and in response to receiving the input corresponding to the user interface element: in accordance with a determination that the input corresponds to a first subject, performing a first operation corresponding to the first subject; and in accordance with a determination that the input corresponds to a second subject, performing a second operation, different from the first operation, corresponding to the second subject, wherein the second subject is different from the first subject.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIG. 3 is a system diagram that illustrates software components of a device in accordance with some embodiments.

FIG. 4 a swim-lane diagram illustrating a technique for a system process to render content of an application using a definition provided by the application in accordance with some embodiments.

FIG. 5 is a flow diagram illustrating a process for displaying content of an application based on state of device in accordance with some embodiments.

FIG. 6 is a flow diagram illustrating a process for performing an operation based on a subject in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms unless explicitly stated with an order and/or that they are separate and/or different. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

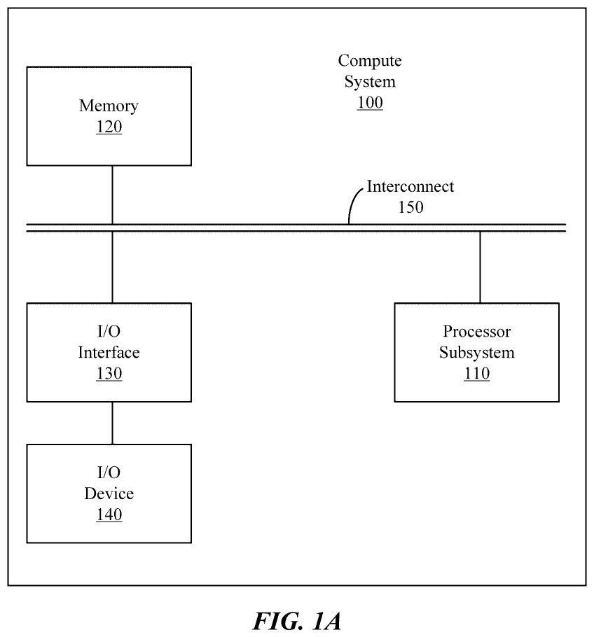

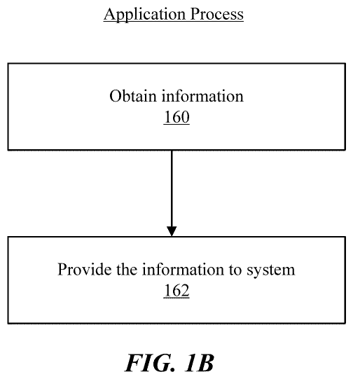

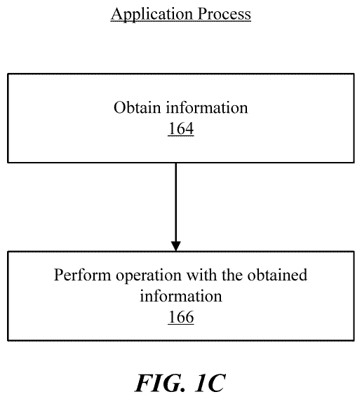

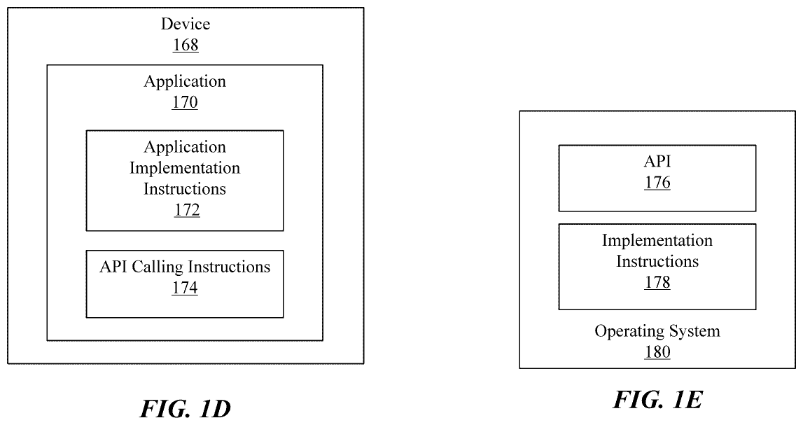

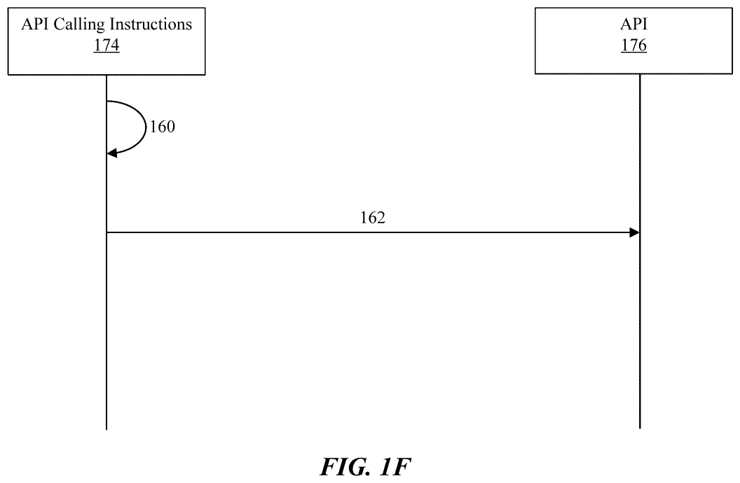

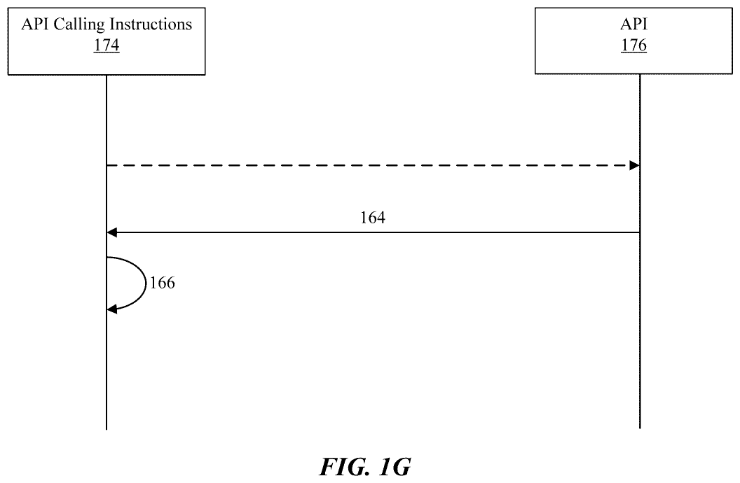

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

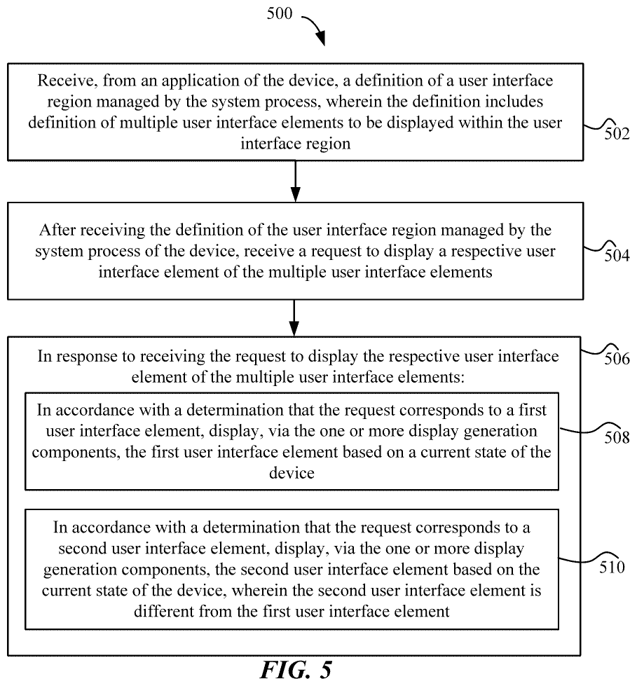

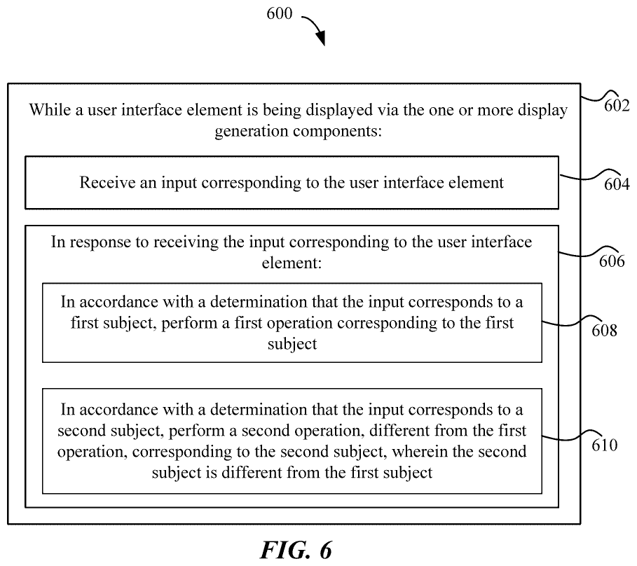

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 500 and 600 (FIGS. 5 and 6) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

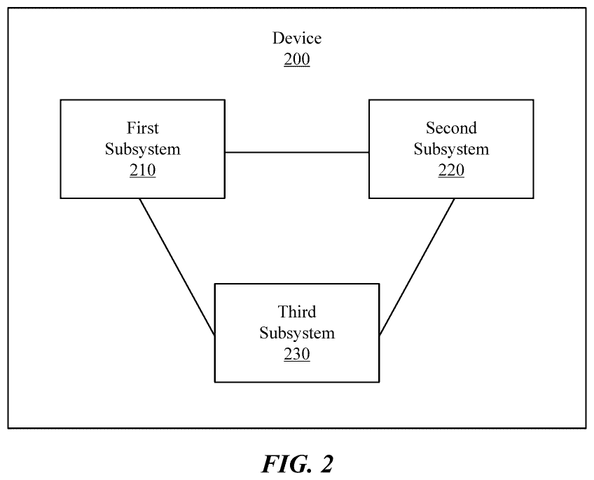

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for displaying content. Such techniques are described in the context of live activities. It should be recognized that other types of content can be used with techniques described herein. For example, information, images, videos, and/or other content can be used with techniques described herein. In addition, techniques optionally complement or replace other techniques for displaying content.

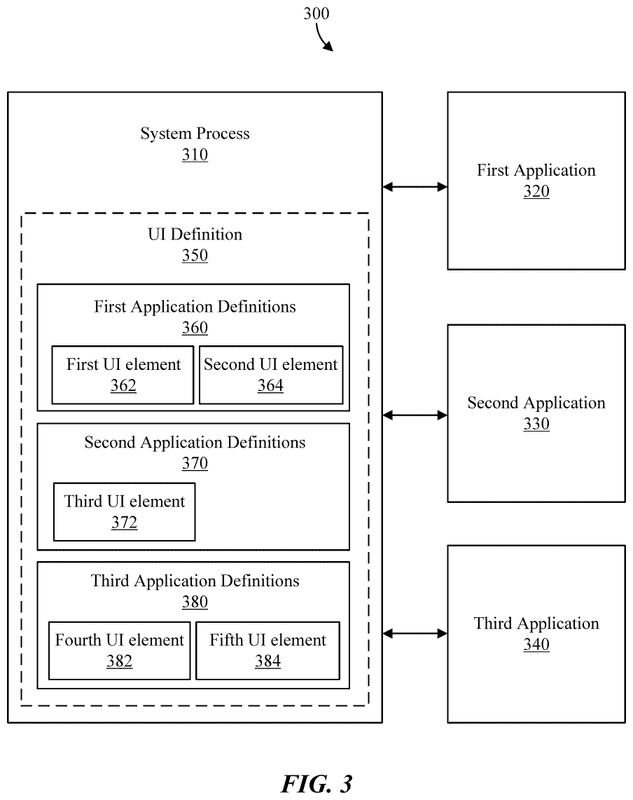

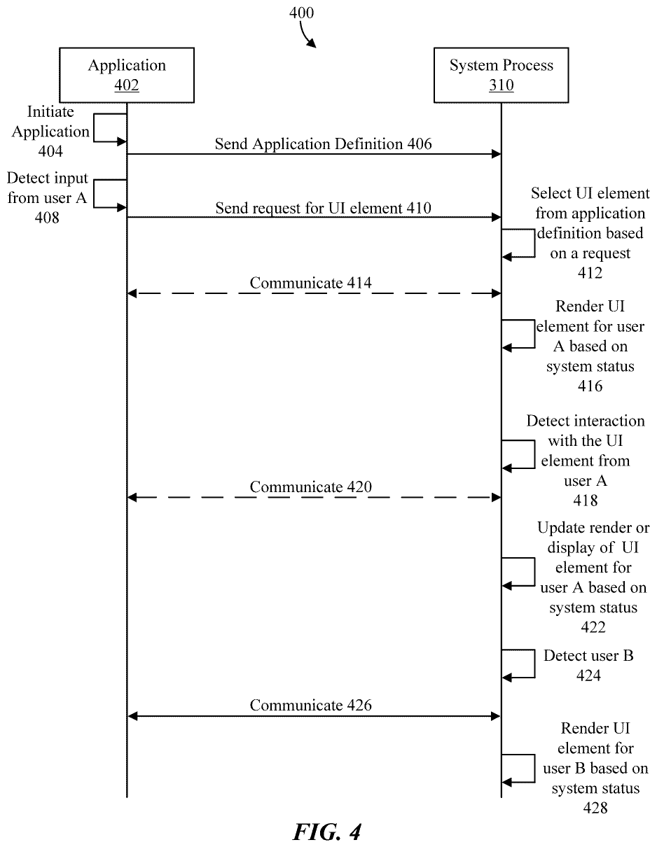

FIG. 3 is a system diagram that illustrates software components of a device in accordance with some embodiments. The system diagram is used to illustrate the processes described below, including the processes in FIGS. 4-6.

As illustrated in FIG. 3, device 300 includes system process 310, first application 320, second application 330, and third application 340. Each of such software components are separate and distinct. It should be recognized that device 300 can include more, fewer, and/or different software components than illustrated in FIG. 3. It should also be recognized that device 300 can be a number of different types of devices, such as a communal device, a smart speaker, a laptop, a desktop, a tablet, a television, a security system, smart phone, a smart watch, a head-mounted display device, a wearable device, and/or a fitness tracking device.

In some embodiments, system process 310 is a process of an operating system of device 300 and performs one or more functions on behalf of the operating system, such as managing a layout of a home screen, launching an application, handling a system alert, controlling a lock screen, managing storage, handling networking, and/or managing security of device 300. For example, system process 310 can manage and/or host display of content for a designated region of a display of device 300. In such an example, the designated region of the display can (1) belong to the operating system and not to any particular application, (2) be dynamic in size, and/or (3) include content from one or more different applications (e.g., 320, 330, and/or 340). In some embodiments, the designated region of the display is managed and/or hosted directly by system process 310. In such embodiments, the designated region can include content from an application while a user interface of another application, different from the application, is currently being displayed and/or while a user interface of the application is not currently being displayed. In addition, modifications to content within the designated region are managed by system process 310 and not an application corresponding to the content. For example, while a widget of an application is displayed within the designed region, changes to the widget are managed by system process 310 such that system process 310 (1) obtains the changes from the application to be made by system process 310 and/or (2) directly causes changes to the widget through the application.

In some embodiments, each application (e.g., 320, 330, and 340) represents a distinct piece of software that is designed to perform one or more specific tasks. Examples of different applications include a clock application, a sports application, a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and a social network application. For purposes of the discussion below, second application 330 is a sports application with the ability to register to follow a team that causes a game widget to be displayed when the team is playing and first application 320 is a clock application with the ability to (1) create a timer and (2) create an alarm. In response to creating a timer, first application 320 causes a timer widget to be displayed that indicates an amount of time remaining on the timer. In response to creating an alarm, first application 320 causes an alarm widget to be displayed when the alarm goes off. With the game widget, the timer widget, and the alarm widget, such widgets are (1) displayed within the designated region mentioned above that is managed by system process 310 and (2) continue to be displayed as different user interfaces of different applications are displayed.

As illustrated in FIG. 3, each of first application 320, second application 330, and third application 340 communicates (e.g., via an Application Programming Interface (API)) with system process 310 and vice versa. In some embodiments, such communication includes communication of definitions from applications to system process 310 for management by system process 310. For example, in response to (or after) an application (e.g., 320, 330, and/or 340) being initialized, the application can provide system process 310 with a definition (e.g., 360, 370, and 380). In some embodiments, the definition includes one or more user interface (UI) element definitions that are used by system process 310 to display corresponding user interface elements. For example, system process 310 can use UI definition 350 to render and/or display content within the designated region of the display in a manner defined by the application.

As illustrated in FIG. 3, UI definition 350 includes multiple application definitions (e.g., 360, 370, and/or 380) provided by different applications of device 300, each application definition (e.g., 360, 370, and/or 380) including one or more UI element definitions (e.g., 362, 364, 372, 382, and/or 384, such as a text field, a button, a check box, a slider, a menu, a toggle switch, a notification, an icon, a window, a widget, a search bar, and/or a search field). For example, first application definition 360 (1) corresponds to and/or is from first application 320 and (2) includes first UI element definition 362 and second UI element definition 364. For purposes of the discussion below, first UI element definition 362 defines the timer widget and second UI element definition 364 defines the alarm widget. For another example, second application definitions 370 (1) corresponds to and/or is from second application 330 and (2) includes third UI element definition 372. For purposes of the discussion below, third UI element definition 372 defines the game widget. For another example, third application definition 380 (1) corresponds to and/or is from third application 340 and (2) includes fourth UI element definition 382 and fifth UI element definition 384. In some embodiments, each application definition (e.g., 360, 370, and/or 380) is provided to system process 310 in a single communication. For example, first UI element definition 362 and second UI element definition 364 can be provided by first application 320 to system process 310 in a single communication such that each definition does not need to be sent separately.

In some embodiments, each UI element definition includes a rendered version of a UI element and/or a process or script for rendering a UI element. For example, each UI element definition can include a definition for a UI element so that system process 310 can render and/or display the UI element based on the definition. In some embodiments, a UI element definition defines how system process 310 should handle a layout configuration, a style parameter, an interactions model, a scene transition, a content style for a specific user, and/or how a UI element should be rendered and/or displayed. For example, the UI element definition can define a specific style (e.g., brightness level, resolution, position, font type, and/or size) of the UI element when device 300 is in different states. Such states can be detected by system process 310, such as an orientation (e.g., portrait and/or landscape) of a display of device 300, which user is interacting with device 300, where a user is located relative to device 300, a configuration and/or a setting of device 300 (e.g., a light mode, a dark mode, and/or a higher or lower power mode), an amount of light in an environment of device 300, an amount of noise in the environment, and/or the like.

As mentioned above, UI element definitions for an application can be included in a single definition. In some embodiments, system process 310 selects an appropriate UI element definition from the single definition as further discussed below with respect to FIG. 4. For example, system process 310 can select an appropriate UI element definition from UI definition 350 when a UI element is requested to be displayed. In the example of the clock application, system process 310 can receive a request for a timer and, in response, select, based on the request including an identifier of the timer widget, between first UI element definition 362 and second UI element definition 364 so as to identify how to respond to the request for the timer.

FIG. 4 is a swim-lane diagram illustrating a technique for a system process to render content of an application using a definition provided by the application in accordance with some embodiments. The swim-lane diagram is used to illustrate the processes described below, including the processes in FIGS. 5-6.

As illustrated in FIG. 4, process 400 is performed by system process 310 and application 402 (e.g., first application 320, second application 330, or third application 340), both operating on a device (e.g., device 300). For purposes of the discussion below, application 402 is first application 320.

Beginning process 400, application 402 is (404) initiated (e.g., launched, started, and/or loaded). For example, application 402 can be initiated when a user launches application 402 or requests a specific operation be performed that is provided by application 402. For another example, application 402 can be initiated when device 300 is powered on and/or changed from a standby mode to a normal mode.

After (and/or in response to) being initiated, application 402 sends (406) an application definition (e.g., first application definition 360) to system process 310. As described above with respect to FIG. 3, the application definition can include rendered UI elements and/or how different UI elements of application 402 are rendered and/or displayed by system process 310. For example, if application 402 has a UI element that relates to a specific function of application 402 (such as a timer widget), the application definition can include a configuration and/or layout of the UI element so that system process 310 can render and/or display the UI element. In some embodiments, the application definition is sent to system process 310 once and is not re-sent every time application 402 is initiated. In such embodiments, application 402 can send new application definitions when previous application definitions are changed or new application definitions are added.

After application 402 sends the application definition to system process 310, application 402 detects (408) an input from user A, such as that user A is in front of device 300 requesting that a user interface be displayed, and/or user A is requesting that device 300 perform an operation. In some embodiments, the input corresponds to a request to display an interactive notification (e.g., live widget, dynamic update, persistent alert, and/or real-time dashboard). For example, the input can be a tap input on a user interface element within application 402 that causes an alarm to be set for 5 minutes from now. In such an example, the widget is not displayed in response to detecting the input but rather is configured to be displayed in the future when the 5 minutes expires. For another example, the input can be a voice request directed to application 402 to start a five-minute timer. In such an example, a widget is displayed in response to detecting the input and is maintained even when no user interface of application 402 is currently being displayed. It should be recognized that such examples of an input are for explanatory purposes and that other inputs can be used with techniques described herein, including notifications received from other devices and/or inputs directed to other applications that use features of application 402.

In response to detecting the input, application 402 sends (410), to system process 310, a request for a UI element to be displayed. The request can be for immediate display or include a condition for which the UI element should be displayed. In some embodiments, the request corresponds to the input from user A. In such embodiments, the request can include an identification of application 402, an identification of the UI element, and/or an identification of user A.

After (and/or in response to) receiving the request for the UI element, system process 310 selects (412) a definition (e.g., the application definition and/or a user interface element definition within the application definition as described above with respect to 406) for the UI element. In some embodiments, the definition is selected by identifying an application definition (e.g., 360) using the identification of application 402 and/or identifying a UI element (e.g., 362) within the application definition using the identification of the UI element.

After (and/or in response to) selecting the definition, system process 310 optionally communicates (414) with application 402, requesting that application 402 provide data for the UI element. Such communication is optional as a result of such information being provided within the request at 410 and/or the definition selected at 412. In some embodiments, as part of communicating at 414, system process 310 requests data corresponding to an operation related to the UI element. For example, system process 310 can request content for display within the UI element. In such an example, application 402 can provide the content to system process 310 so that system process 310 can include the content in the UI element. In some embodiments, the content includes one or more rendered elements that are provided by application 402 to system process 310 for display by system process 310.

After (and/or in response to) receiving the request at 410, after (and/or in response to) selecting the definition, and/or after (and/or in response to) communicating with application 402, system process 310 renders and/or displays (416) the UI element for user A based on a system status of device 300. In some embodiments, the system status is detected by one or more input devices (e.g., a sensor, a camera, and/or a microphone) that are in communication (and/or included) with device 300. For example, device 300 can include a gyroscope that detects an orientation of device 300. In such an example, the system status can be whether the orientation of device 300 corresponds to a portrait or landscape mode, causing the UI element to be rendered and/or displayed differently depending on which mode is active (and/or selected). For another example, device 300 can include a light detector that detects an amount of light. In such an example, the system status can be whether the amount of light satisfies a threshold, causing the UI element to be rendered and/or displayed differently depending on whether the threshold is satisfied. For another example, the system status can be determined based on a detection of a user and a determination of whether the user is registered with device 300. For example, device 300 can detect user A via the one or more input devices and/or by receiving a communication from a personal device of user A identifying user A. After detecting user A, device 300 determines whether user A is a registered user of device 300 using image, voice, and/or biometric recognition of user A and/or the communication from the personal device of user A. In some embodiments, in the scenario where user A is a registered user, system process 310 renders a UI element that is personalized for user A based on the UI element definition (e.g., 362, 364, 372, 382, and 384) sent by the application (e.g., 320, 330, or 340). For example, the timer widget can be colored in a way that user A defined using the timer application.

After rendering the UI element for user A (and/or while the UI element is currently being displayed), system process 310 detects (418) an interaction with the UI element from user A. In some embodiments, system process 310 detects the interaction with the UI element via the one or more input devices. In some embodiments, the interaction with the UI element is a selection input, such as a voice command, touch input, and/or an air gesture directed to the UI element. In some embodiments, the interaction with the UI element corresponds to a request to change a style (e.g., a font, a position, a brightness, a color scheme, an animation, and/or a size) in which the UI element is presented. For example, the interaction with the UI element can be a request to expand or minimize the UI element.

In response to detecting the interaction with the UI element from user A, system process 310 optionally communicates (420) with application 402. For example, when the interaction with the UI element is a request to expand the UI element, system process 310 can alert application 402 of the request and/or request additional information for resolving the request. After application 402 is alerted of the request, application 402 processes the request and sends data corresponding to the request to system process 310. Such communication is optional as a result of application 402 not needing to be alerted and/or additional information not being required.

After (and/or in response to) detecting the interaction with the UI element (and/or in response to communicating with application 402), system process 310 updates (422) render and/or display of the UI element requested by user A based on a system status of device 300. The system status can be determined as described above with respect to 416. For example, if user A requests a video from application A, system process 310 can display the video in a specific style (e.g., size, position, brightness level, and/or resolution) based on a UI element definition corresponding to the request and the system status such as a detection of a user and/or orientation of device 300. It should be recognized that, in some embodiments, as part of updating render of the UI element, system process 310 selects the UI element definition corresponding to the UI element from the application definition. In other embodiments, the UI element definition is previously selected (e.g., at 412) and does not need to be re-selected while the UI element is displayed.

After rendering the UI element for user A based on the system status, system process 310 detects (424) user B. Similar to as described above, system process 310 can detect user B from an input detected via the one or more input devices. In some embodiments, system process 310 detects user B after no longer detecting user A. In such embodiments, user A might have left an environment in which device 300 is located for more than a predetermined period of time or might have shown a threshold level of inactivity toward device 300.

After detecting user B, system process 310 communicates (426) with application 402. In some embodiments, system process 310 alerts application 402 of the detection of user B and/or alerts application 402 of which user (user A and/or user B) is interacting with device 300. For example, when system process 310 determines that user A is no longer interacting with device 300 and user B is now interacting with device 300, system process 310 informs application 402 of the change in user. In some embodiments, application 402 can determine if user B is a registered user and make a determination of whether data is processed differently for user B. For example, if user A was viewing content that was determined to be specific for user A, application 402 can communicate to system process 310 that the data should not be displayed by system process 310 after user A is no longer detected in the environment.

After communicating with application 402 about detection of user B, system process 310 renders (428) the UI element for user B based on a system status. The system status can be determined as described above with respect to 416. For example, the system status can include whether or not user B is now a primary user of device 300. In conjunction with system process 310 determining the system status, system process 310 selects the UI element definition corresponding to the UI element from the application definition and renders the UI element accordingly to the UI element definition and the system status. For example, if the UI element definition designates for user B a specific style (e.g., style and/or font) for the UI element, system process 310 can render the UI element with the specific style. Using the example described above with the timer widget, system process 310 can determine that the timer widget being displayed while detecting user A was for user A and not for user B. In such an example, system process 310 can remove display of the timer widget and, if user B also has an on-going timer, display a timer widget for the on-going timer of user B. For another example, system process 310 can determine that a user interface element currently being displayed corresponds to an operation to turn on a morning alarm for a user. In response to user A interacting with the user interface element, system process 310 causes a morning alarm of user A to be turned on for the next morning. Alternatively, in response to user B interacting with the user interface element, system process 310 causes a morning alarm of user B to be turned on for the next morning. In such an example, the morning alarm of user A can be 7 AM while the morning alarm of user B can be 9 AM. Accordingly, depending on who is detected to be interacting with the user interface element, a different alarm is set for the morning (e.g., 7 AM or 9 AM). In some embodiments, the user interacting with the user interface element is determined via a camera, such as who is in front of device 300, or via a personal device of a user, such as whichever personal device is closest to device 300.

FIG. 5 is a flow diagram illustrating a process (e.g., process 500) for displaying content of an application based on state of device in accordance with some embodiments. Some operations in process 500 are, optionally, combined, the orders of some operations are, optionally, changed, and some operations are, optionally, omitted.

As described below, process 500 provides an intuitive way for displaying content of an application based on state of device. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a device (e.g., 300), by a system process (e.g., 310), that is in communication with (and/or includes) one or more display generation components (e.g., as described above with respect to FIG. 3) (e.g., a display screen, a projector, a head mounted display, and/or a touch-sensitive display). In some embodiments, the device is a communal device, a watch, a phone, a tablet, a fitness tracking device, a processor, a head-mounted display (HMD) device, a media device, a speaker, a television, an electronic device, and/or a personal computing device. In some embodiments, the system process is part of and/or executing on behalf of an operating system (e.g., as described above with respect to FIG. 3) of the device.

The system process receives (502), from an application (e.g., 320, 330, 340, and/or 402) (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) of the device, a definition (e.g., a data structure, a list, a layout, an organization, a structure, an arrangement, a framework, and/or a composition) (e.g., 360, 370, and/380) of a user interface region (e.g., as described above with respect to FIG. 3) (e.g., a user interface space, a user interface area, a user interface section, a user interface zone, and/or a user interface view) managed (e.g., hosted and/or controlled) (e.g., as described above with respect to FIG. 3) by the system process (e.g., and not managed by the application, such that the application has to provide, to the system process, content to be displayed within the user interface region by the system process), wherein the definition includes definition (e.g., a layout, an organization, a structure, an arrangement, a framework, and/or a composition) (e.g., 362, 364, 372, 382, and/or 384) of multiple user interface elements (e.g., a possible user interface element, a virtual button, an icon, a widget, a control, and/or a window) to be displayed within the user interface region. In some embodiments, the definition of the user interface region is multiplexed. In some embodiments, the device is concurrently executing the application and the system process. In some embodiments, the definition of the user interface region is received by the system process while installing the application on the device. In some embodiments, the definition of the user interface region is provided to the system process when the application is initiated. In some embodiments, the definition of the user interface region is provided to the system process while the application is executing on the device. In some embodiments, the user interface region corresponds to an area of display space that is managed by the system process. In some embodiments, the user interface region corresponds to an area of display space of the one or more display generation components. In some embodiments, the definition is received by the system process in a single message. In some embodiments, the multiple user interface elements include a first user interface element and a second user interface element separate from the first user interface element. In some embodiments, the first user interface element and/or the second user interface element are provided by the application to the system process for display by the system process. In some embodiments, the definition is to pre-configure the multiple user interface elements with the system process so that the system process can display one or more of the multiple user interface elements at a later point in time.

After receiving the definition of the user interface region managed by the system process of the device, the system process receives (504) (e.g., from the application or another process different and/or separate from the application) a request (e.g., 408) (e.g., separate from the definition) to display a respective user interface element of the multiple user interface elements. In some embodiments, receiving the request to display the respective user interface element of the multiple user interface elements includes detecting, via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) that are in communication with (and/or included in) the device, an input (e.g., a tap input and/or a voice command) corresponding to request to display the respective user interface element of the multiple user interface elements. In some embodiments, the request to display the respective user interface element of the multiple user interface elements includes an identifier provided in the definition. In some embodiments, the identifier is used to distinguish between a definition of the first user interface element and a definition of the second user interface element included in the definition of the user interface region.

In response to (506) receiving the request to display the respective user interface element of the multiple user interface elements, in accordance with a determination (e.g., based on the definition of the user interface region) that the request corresponds to a first user interface element (e.g., defined by 362, 364, 372, 382, and/or 384) (and/or that the respective user interface element of the multiple user interface elements is the first user interface element), the system process displays (508), via the one or more display generation components, the first user interface element based on a current state (e.g., as described above with respect to FIG. 4) (e.g., an operating state and/or a display state) of the device (e.g., the first user interface element has a different appearance depending on which state that the device is in, such as whether the device is in landscape or portrait mode, displaying another user interface element within the user interface region, displaying a particular user interface element, playing a video, in a lower powered or higher powered mode, and/or display is restricted to one or more colors or not restricted to one or more colors) (e.g., as described above with respect to FIG. 4, such as after rendering at 416 and/or 428). In some embodiments, the first user element is a user interface element such as a notification, a real-time update, a dynamic widget, a live widget, a persistent notification, an active tile, a streaming info panel, and/or a floating update. In some embodiments, the first user interface element is based on an identification of a subject interacting with the device (e.g., the first user interface element has a different appearance depending on which subject is interacting with the device). In some embodiments, the first user interface element is based on one or more conditions of an environment in which the device is in (e.g., the first user interface element has a different appearance depending on a condition of the environment in which the device is in, such as the environment being brighter or darker, the environment being a private or public area, and/or the environment including a subject performing one activity or another). In some embodiments, the determination that the respective user element of the multiple user interface elements is the first user interface element includes selection of the first user interface element from the multiple user interface elements based on the definition of the user interface region. In some embodiments, data from the request is used to identify the first user interface element based on the definition of the user interface region, such as the request includes an identification of the first user interface element that is matched with an identification of the first user interface element within the definition of the user interface region.

In response to (506) receiving the request to display the respective user interface element of the multiple user interface elements, in accordance with a determination (e.g., based on the definition of the user interface region) that the request corresponds to a second user interface element (e.g., defined by 362, 364, 372, 382, and/or 384) (and/or that the respective user interface element of the multiple user interface elements is the second user interface element), the system process displays (510), via the one or more display generation components, the second user interface element based on the current state of the device (e.g., as described above with respect to FIG. 4, such as after rendering at 416 and/or 428), wherein the second user interface element is different (and/or separate) from the first user interface element. In some embodiments, the second user element is a user interface element such as a notification, a real-time update, a dynamic widget, a live widget, a persistent notification, an active tile, a streaming info panel, and/or a floating update. In some embodiments, the determination that the respective user element of the multiple user interface elements is the second user interface element includes selection of the second user interface element from the multiple user interface elements based on the definition of the user interface region. In some embodiments, data from the request is used to identify the second user interface element based on the definition of the user interface region, such as the request includes an identification of the second user interface element that is matched with an identification of the second user interface element within the definition of the user interface region.

In some embodiments, each of the multiple user interface elements are managed (and/or hosted) by the system process. In some embodiments, each of the multiple user interface elements includes content (e.g., defined by 362, 364, 372, 382, and/or 384) (e.g., video, images, audio, and/or personalized content) provided (e.g., created, generated, and/or retrieved) by the application. In some embodiments, the content is provided to the system process by the application after the system process sends a request to the application. In some embodiments, the content is included in the definition of the user interface region. In some embodiments, the content is not included in the definition of the user interface region and is instead provided to the system process with the request to display the respective user interface element or after receiving the request to display the respective user interface element. In some embodiments, the system process manages an appearance (e.g., position, size, and/or color) of each of the multiple user interface elements within the user interface region. In some embodiments, each of the multiple user interface elements includes different content (e.g., video, images, audio, and/or personalized content) provided (e.g., created, generated, and/or retrieved) by the application (e.g., a first user interface element includes different content provided by the application than a second user interface element different from the first user interface element).

In some embodiments, the application is a first application (e.g., 320). In some embodiments, the definition of the user interface region managed by the system process is a first definition (e.g., 360) of the user interface region managed by the system process. In some embodiments, the respective user interface element of the multiple user interface elements is a first respective user interface element (e.g., defined by 362) of the multiple user interface elements. In some embodiments, after receiving (and/or before receiving and/or while receiving), from the first application of the device, the first definition of the user interface region managed by the system process, the system process receives, from a second application (e.g., 330 and/or 340) (e.g., a home application, a note-taking application, a word-processing application, a document-processing application, a presentation application, an email application, a form processing application such as for a PDF viewer and/or editor, a game, a messaging application, a maps application, a fitness application, a health application, a digital payments application, a media application, and/or a social network application) different from the first application, a second definition (e.g., 370 and/or 380) (e.g., a data structure, a list, a layout, an organization, a structure, an arrangement, a framework, and/or a composition) of the user interface region (e.g., a user interface space, a user interface area, a user interface section, a user interface zone, and/or a user interface view) managed by the system process, wherein the second definition includes a second definition (e.g., 372, 382, and/or 384) of multiple user interface elements to be displayed with the user interface region, wherein the second definition of the user interface region is separate from the first definition of the user interface region. In some embodiments, the second definition of the multiple user interface elements is different from the first definition of the multiple user interface elements. In some embodiments, after receiving the second definition of the user interface region managed by the system process of the device, the system process receives (e.g., from the second application or another process different and/or separate from the second application) a request (e.g., as described with respect to FIG. 4) (e.g., separate from the second definition) to display a second respective user interface element (e.g., as described with respect to FIG. 4) of the multiple user interface elements. In some embodiments, receiving the request to display the second respective user interface element of the multiple user interface elements includes detecting, via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) that are in communication with (and/or included in) the device, an input (e.g., a tap input and/or a voice command) corresponding to request to display the second respective user interface element of the multiple user interface elements. In some embodiments, the request to display the second respective user interface element of the multiple user interface elements includes an identifier provided in the second definition. In some embodiments, the identifier is used to distinguish between a definition of the first user interface element and a definition of the second user interface element included in the second definition of the user interface region. In some embodiments, in response to receiving the request to display the second respective user interface element of the multiple user interface elements, in accordance with a determination (e.g., based on the second definition of the user interface region) that the request to display the second respective user interface element corresponds to a third user interface element (e.g., as defined by 372) (and/or that the second respective user interface element of the multiple user interface elements is the third user interface element), the system process displays, via the one or more display generation components, the third user interface element based on the current state of the device (e.g., as described above with respect to FIG. 4). In some embodiments, in response to receiving the request to display the second respective user interface element of the multiple user interface elements, in accordance with a determination (e.g., based on the second definition of the user interface region) that the request to display the second respective user interface element corresponds to a fourth user interface element (e.g., as defined by 382 and/or 384) (and/or that the second respective user interface element of the multiple user interface elements is the fourth user interface element), the system process displays, via the one or more display generation components, the fourth user interface element based on the current state of the device, wherein the third user interface element is different from the fourth user interface element.

In some embodiments, the application is a first application (e.g., 320). In some embodiments, while displaying the first user interface element based on the current state of the device, the system process receives (e.g., from the application or another process different and/or separate from the application) a request (e.g., separate from the definition) to display a user interface (e.g., defined by 372) (e.g., digital interface, menu system, operating interface, and/or control panel) of a second application (e.g., 330) (e.g., a home application, a note-taking application, a word-processing application, a document-processing application, a presentation application, an email application, a form processing application such as for a PDF viewer and/or editor, a game, a messaging application, a maps application, a fitness application, a health application, a digital payments application, a media application, and/or a social network application) different from the first application. In some embodiments, the request to display the user interface of the second application is a tap input, voice command, and/or gaze input. In some embodiments, in response to receiving the request to display the user interface of the second application, the system process displays, via the one or more display generation components, the user interface of the second application while maintaining display of the first user interface element.

In some embodiments, while displaying the first user interface element and the user interface of the second application, the system process receives (e.g., from the application or another process different and/or separate from the application) a request (e.g., separate from the definition) to display a user interface (e.g., that includes a user interface element defined by 382 and/or 384) (e.g., digital interface, menu system, operating interface, and/or control panel) of a third application (e.g., 340) (e.g., a home application, a note-taking application, a word-processing application, a document-processing application, a presentation application, an email application, a form processing application such as for a PDF viewer and/or editor, a game, a messaging application, a maps application, a fitness application, a health application, a digital payments application, a media application, and/or a social network application) different from the first application and the second application. In some embodiments, in response to receiving the request to display the user interface of the third application, the system process displays, via the one or more display generation components, the user interface of the third application while maintaining display of the first user interface element. In some embodiments, the request to display the user interface of the third application is a tap input, voice command, and/or gaze input. In some embodiments, in response to receiving the request to display the user interface of the third application, the device ceases display of the user interface of the second application.

In some embodiments, the user interface of the second application is a first user interface (e.g., defined by 372) of the second application. In some embodiments, while displaying the first user interface element and the first user interface of the second application, the system process receives (e.g., from the application or another process different and/or separate from the application) a request (e.g., 418) (e.g., separate from the definition) to display a second user interface of the second application, wherein the second user interface of the second application is different from the first user interface of the second application. In some embodiments, in response to receiving the request to display the second user interface of the second application, the system process displays, via the one or more display generation components, the second user interface of the second application while maintaining display of the first user interface element.

In some embodiments, in conjunction with (e.g., before, while, after, or in response to) displaying the first user interface element based on the current state of the device, the system process retrieves, from the application, content (e.g., data, image, audio, text, and/or video), wherein the first user interface element includes the content (e.g., as described above with respect to FIG. 4). In some embodiments, the content corresponds to an operation associated with the first user interface element.

In some embodiments, displaying the first user interface element based on the current state includes: in accordance with a determination that the current state of the device is a first state (e.g., an operating state and/or a display state), displaying, via the one or more display generation components, the first user interface element in a first style (e.g., defined by 362) (e.g., a size, a position, a personalization, a font, and/or a color); and in accordance with a determination that the current state of the device is a second state (e.g., an operating state and/or a display state), displaying, via the one or more display generation components, the first user interface element in a second style (e.g., defined by 364) (e.g., a size, a position, a personalization, a font, and/or a color) different from the first style. In some embodiments, the second state is different from the first state. In some embodiments, the second style is defined in the definition. In some embodiments, the second style is defined outside of the definition. In some embodiments, the second state is when the device is in portrait mode, such as oriented in a way that content is displayed in the portrait mode. In some embodiments, the second style is a set of colors that are defined to be used (and/or a set of colors that are defined not to be used). In some embodiments, the first style is defined in the definition. In some embodiments, the first style is defined outside of the definition. In some embodiments, the first state is when the device is in landscape mode, such as oriented in a way that content is displayed in the landscape mode. In some embodiments, the first style is a set of colors that are defined to be used (and/or a set of colors that are defined not to be used).

In some embodiments, before displaying the first user interface element in the first style, the system process receives, from the application, an indication (e.g., defined by 362) (e.g., an assignment, a selection, and/or a value) of the first style and an indication (e.g., defined by 364) of the second style, wherein the indication of the first style is different from the indication of the second style. In some embodiments, the system process receives the indication of the first style and/or the indication of the second style from another system process of the device or another device. In some embodiments, the indication of the first style and/or the indication of the second style is included in the definition.

In some embodiments, displaying the first user interface element based on the current state of the device includes displaying the first user interface element with a first appearance (e.g., as defined by 362) (e.g., a size, a position, a color, and/or an emphasis). In some embodiments, while displaying the first user interface element with the first appearance, the system process receives, from the application, an indication (e.g., an alert and/or a notification) of a user input corresponding to the first user interface element. In some embodiments, the user input is a tap input, a voice command, and/or a gaze input. In some embodiments, in response to receiving the indication of the user input corresponding to the first user interface element, in accordance with a determination that the user input is a first input, the system process displays, via the one or more display generation components, the first user interface element with a second appearance (e.g., as defined by 362) (e.g., a size, a position, a color, and/or an emphasis) different from the first appearance (e.g. without displaying the first user interface element with the first appearance). In some embodiments, the first input corresponds to a first button within the first user interface element. In some embodiments, the first user interface element changes from a first size to a second size different from the first size as a result of displaying the first user interface element with the second appearance. In some embodiments, the first user interface moves from a first position to a second position different from the first position as a result of displaying the first user interface element with the second appearance. In some embodiments, in response to receiving the indication of the user input corresponding to the first user interface element, in accordance with a determination that the user input is a second input, the system process forgoes display of, via the one or more display generation components, the first user interface element with the second appearance, wherein the second input is different from the first input. In some embodiments, the second input corresponds to a command to terminate the first user interface element. In some embodiments, the first input corresponds to a second button, different from the first button, within the first user interface element. In some embodiments, in response to receiving the indication of the user input corresponding to the first user interface element and in accordance with the determination that the user input is the second input, the device displays the first user interface element with another appearance different from the first appearance and the second appearance. In some embodiments, in response to receiving the indication of the user input corresponding to the first user interface element and in accordance with the determination that the user input is the second input, the device ceases display of the first user interface element. In some embodiments, in response to receiving the indication of the user input corresponding to the first user interface element and in accordance with the determination that the user input is the second input, the device maintains display of the first user interface element with the first appearance.

In some embodiments, the device is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, before displaying the first user interface element (e.g., defined by 362) based on the current state of the device, the system process detects, via the one or more input devices, a respective subject (e.g., a user, a person, an animal, another computer system different from the computer system, a device, and/or an object) in an environment, wherein the first user interface element includes: in accordance with a determination that the respective subject is recognized (and/or identified) as a first subject, content corresponding to the first subject (e.g., as described above with respect to FIG. 4); and in accordance with a determination that the respective subject is recognized (and/or identified) as a second subject, content corresponding to the second subject (e.g., as described above with respect to FIG. 4) (e.g., without including the content corresponding to the first subject), wherein the second subject is different from the first subject, and wherein the content corresponding to the second subject is different from the content corresponding to the first subject. In some embodiments, the respective subject is recognized by the device using image, pattern, and/or voice recognition. In some embodiments, the respective subject is recognized by the device by receiving information from a personal device (e.g., watch, smart phone, and/or tablet) of the respective subject. In some embodiments, the content corresponding to the first subject is obtained via a personal device of the first subject. In some embodiments, the content corresponding to the first subject is stored on the device. In some embodiments, the content corresponding to the second subject is obtained via a personal device of the second subject. In some embodiments, the content corresponding to the second subject is stored on the device.

In some embodiments, the current state of the device includes (and/or is based on) a current orientation (and/or a current position) (e.g., landscape, portrait, facing up, facing down, or angled toward a particular direction) of the device (e.g., as described above with respect to FIG. 4) (and/or of the one or more display generation components).

In some embodiments, the current state of the device includes (and/or is based on) a text size setting of the device. In some embodiments, the text size setting is used by the device to change a size of text displayed by the device.

In some embodiments, the current state of the device includes (and/or is based on) a number of user interface elements currently displayed within the user interface region.

In some embodiments, the current state of the device includes (and/or is based on) a display mode (e.g., as described above with respect to FIG. 3) (e.g., dark mode, light mode, and/or a mode that causes a brightness level and/or a set of one or more colors to be used) of the one or more display generation components.

In some embodiments, the current state of the device includes (and/or is based on) whether the device is in an inactive or active mode (e.g., an inactive operational or active operational mode, such as when the one or more display generation components are off or on and/or when the one or more display generation components are dimmed or not).

In some embodiments, the current state of the device includes (and/or is based on) whether the device is in a locked or unlocked mode. In some embodiments, a locked mode is when the device is limiting operations that are able to be performed until the device is in an unlocked mode.

Note that details of the processes described above with respect to process 500 (e.g., FIG. 5) are also applicable in an analogous manner to other processes described herein. For example, process 600 optionally includes one or more of the characteristics of the various processes described above with reference to process 500. For example, the content of process 500 can be displayed in response to the operation of process 600. For brevity, these details are not repeated herein.

FIG. 6 is a flow diagram illustrating a process (e.g., process 600) for performing an operation based on a subject in accordance with some embodiments. Some operations in process 600 are, optionally, combined, the orders of some operations are, optionally, changed, and some operations are, optionally, omitted.

As described below, process 600 provides an intuitive way for performing an operation based on a subject. Process 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at a device (e.g., 300), by an application (e.g., 320, 330, and/or 340) (e.g., a home application, a note-taking application, a word-processing application, a document-processing application, a presentation application, an email application, a form processing application such as for a PDF viewer and/or editor, a game, a messaging application, a maps application, a fitness application, a health application, a digital payments application, a media application, and/or a social network application), that is in communication with (and/or includes) one or more display generation components (e.g., as described above with respect to FIG. 3) (e.g., a display screen, a projector, a head mounted display, and/or a touch-sensitive display). In some embodiments, the device is a communal device, a watch, a phone, a tablet, a fitness tracking device, a processor, a head-mounted display (HMD) device, a media device, a speaker, a television, an electronic device, and/or a personal computing device.

While (602) a user interface element (e.g., defined by 362, 364, 372, 382, and/or 384) (e.g., a virtual button, an icon, a widget, a control, and/or a window, such as a user interface element corresponding to the application) is being displayed (e.g., by the application, another application different from the application, or a system process of the device) via the one or more display generation components, the application receives (604) an input (e.g., 418) corresponding to (e.g., related to, directed at, and/or associated with) the user interface element. In some embodiments, the device is in communication with and/or includes one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, receiving the input corresponding to the user interface element includes detecting, via the one or more input devices, an input (e.g., a tap input and/or a voice command). In some embodiments, the input corresponding to the user interface element corresponds to an input detected via the one or more input devices. In some embodiments, the input corresponding to the user interface element is a message received from one or more system processes, such as the system process or another system process (e.g., a system process managing interactions with an input device of the one or more input devices) different from the system process. In some embodiments, the input corresponding to the user interface element is a notification that an input was detected via the one or more input devices that corresponds to the user interface element. In some embodiments, the system process is part of and/or executing on behalf of an operating system (e.g., as described above with respect to FIG. 3) of the device. In some embodiments, the user interface element includes (and/or is) a notification and/or a dynamic activity (e.g., real-time updates, dynamic widgets, live widgets, persistent notifications, active tiles, streaming info panels, and/or floating updates) of the application.

While (602) the user interface element is being displayed via the one or more display generation components, in response to (606) (and/or after) receiving the input corresponding to the user interface element, in accordance with a determination that the input corresponds to a first subject (e.g., a first user, a first person, a first animal, a first computer system, a first device different from the device, and/or a first object), the application performs (608) a first operation (e.g., 422 as described above with respect to FIG. 4) corresponding to (e.g., related to and/or associated with) the first subject. In some embodiments, the determination that the input corresponds to the first subject is based on biometric data detected before and/or while receiving the input corresponding to the user interface element. In some embodiments, the determination that the input corresponds to the first subject is based on data received (e.g., before and/or while receiving the input corresponding to the user interface element) from a personal device of the first subject. In some embodiments, performing the first operation includes outputting content in a first manner (e.g., size, emphasis, font, and/or volume) for the first subject. In some embodiments, performing the first operation includes performing an operation that is catered to the first subject. In some embodiments, performing the first operation includes performing an operation using data corresponding to and/or associated with the first subject. In some embodiments, the determination that the input corresponds to the first subject includes a determination that the first subject is detected (e.g., via the one or more input devices) in an environment of the device.

While (602) the user interface element is being displayed via the one or more display generation components, in response to (606) receiving the input corresponding to the user interface element, in accordance with a determination that the input corresponds to a second subject (e.g., a second user, a second person, a second animal, a second computer system, a second device different from the device, and/or a second object), the application performs (610) a second operation (e.g., 428 as described above with respect to FIG. 4), different from the first operation, corresponding to the second subject (e.g., without performing the first operation corresponding to the first subject), wherein the second subject is different from the first subject. In some embodiments, the determination that the input corresponds to the second subject is based on biometric data detected before and/or while receiving the input corresponding to the user interface element. In some embodiments, the determination that the input corresponds to the second subject is based on data received (e.g., before and/or while receiving the input corresponding to the user interface element) from a personal device of the second subject. In some embodiments, performing the second operation includes outputting content in a second manner (e.g., size, emphasis, font, and/or volume), different from the first manner, for the second subject. In some embodiments, performing the second operation includes performing an operation that is catered to the second subject (e.g., without being catered to the first subject). In some embodiments, performing the second operation includes performing an operation using data corresponding to and/or associated with the second subject. In some embodiments, the determination that the input corresponds to the second subject includes a determination that the second subject is detected (e.g., via the one or more input devices) in the environment of the device. In some embodiments, the second operation is different from the first operation in that the second operation corresponds to the second subject and the first operation corresponds to the first subject (e.g., the same type of operation is performed using different data).

In some embodiments, the input corresponding to the user interface element includes an identifier (e.g., identification information, a username, an account name, a unique identifier, a name, biometric data, behavior data, a device identifier, and/or authentication data) of a respective subject (e.g., as described above with respect to FIG. 4) (e.g., the first subject when the input corresponds to the first subject and the second subject when the input corresponds to the second subject).

In some embodiments, the input corresponding to the user interface element includes an identification of a portion (and/or area) of the user interface element (e.g., as described above with respect to FIG. 4). In some embodiments, the portion of the user interface elements includes a button and/or a background area. In some embodiments, the portion of the user interface element is a location of the input that was detected via the device.

In some embodiments, the application is a first application (e.g., 320). In some embodiments, the user interface element is a first user interface element (e.g., defined by 362). In some embodiments, the first user interface element corresponds to (e.g., is related to, generated by, and/or associated with) the first application. In some embodiments, while displaying the first user interface element, the application displays, via the one or more display generation components, a second user interface element (e.g., defined by 372, 382, and/or 384) different from the first user interface element, wherein the second user interface element corresponds to (e.g., related to, generated by, and/or associated with) a second application (e.g., 330 and/or 340) (e.g., and does not correspond to the first application) different from the first application.

In some embodiments, the first operation corresponds to (e.g., related to and/or associated with) the first subject (e.g., without corresponding and/or does not correspond to the second subject). In some embodiments, the second operation corresponds to (e.g., related to and/or associated with) the second subject (e.g., as described above with respect to FIG. 4) (e.g., without corresponding and/or does not correspond to the first subject). In some embodiments, the first operation includes and/or uses personalized data and/or personalized settings for the first subject. In some embodiments, the second operation includes and/or uses personalized data and/or personalized settings for the second subject.

In some embodiments, the first operation is a first type of operation (e.g., 422) (e.g., a display operation, a navigation operation, a submission operation, a cancellation operation, a media control operation, and/or a social interaction operation). In some embodiments, the second operation is the first type of operation (e.g., 428). In some embodiments, the first operation is different from the second operation in data that is used to perform the operation (e.g., data specific to a subject).

In some embodiments, the input corresponding to the user interface element is received from a system process (e.g. 310) of the device. In some embodiments, the system process is part of and/or executing on behalf of an operating system of the device.

In some embodiments, the user interface element is managed (e.g., hosted and/or controlled) by the system process (e.g., as described above with respect to FIG. 3).

In some embodiments, before receiving the input corresponding to the user interface element, the application sends, to a system process of the device, a definition (e.g., 362, 364, 372, 382, and/or 384) (e.g., a data structure, a list, a layout, an organization, a structure, an arrangement, a framework, and/or a composition) of the user interface element. In some embodiments, the definition includes definition of multiple user interface elements to be displayed within a user interface region (e.g., a user interface space, a user interface area, a user interface section, a user interface zone, and/or a user interface view). In some embodiments, the system process is part of and/or executing on behalf of an operating system of the device.

In some embodiments, the device is in communication with (and/or includes) one or more cameras (e.g., a periscope camera, a telephoto camera, a wide-angle camera, and/or an ultra-wide-angle camera). In some embodiments, the determination that the input corresponds to the first subject includes identifying the first subject using content (e.g., image, video, and/or audio) captured via the one or more cameras (e.g., as described above with respect to FIG. 4, such as after detecting user A at 418). In some embodiments, identifying the first subject includes using facial and/or pattern recognition on the content captured via the one or more cameras. In some embodiments, identifying the first subject includes using voice recognition on the content captured via the one or more cameras. In some embodiments, identifying the first subject includes using machine learning on the content captured via the one or more cameras. In some embodiments, the determination that the input corresponds to the second subject includes identifying the second subject using the content captured via the one or more cameras (e.g., as described above with respect to FIG. 4, such as after detecting user B at 424). In some embodiments, identifying the second subject includes using facial and/or pattern recognition on the content captured via the one or more cameras. In some embodiments, identifying the second subject includes using voice recognition on the content captured via the one or more cameras. In some embodiments, identifying the second subject includes using machine learning on the content captured via the one or more cameras.

In some embodiments, the determination that the input corresponds to the first subject is based on receiving a communication (e.g., an IP address, an identifier, and/or a device name) from a personal device of the first subject (e.g., as described above with respect to FIG. 4) (e.g., and not receiving a communication from a personal device of the second subject). In some embodiments, the determination that the input corresponds to the second subject is based on receiving a communication (e.g., an IP address, an identifier, and/or a device name) from a personal device of the second subject (e.g., as described above with respect to FIG. 4) (e.g., and not receiving a communication from a personal device of the first subject).

Note that details of the processes described above with respect to process 600 (e.g., FIG. 6) are also applicable in an analogous manner to the processes described herein. For example, process 500 optionally includes one or more of the characteristics of the various processes described herein with reference to process 600. For example, the operation of process 600 can occur while displaying the content of process 500. For brevity, these details are not repeated herein.

In some embodiments, one or more of processes 500 and 600 (FIGS. 5 and 6) is performed at a first computer system (as described herein) via a system process (e.g., an operating system process and/or a server system process) that is different from one or more applications executing and/or installed on the first computer system.

In some embodiments, one or more of processes 500 and 600 (FIGS. 5 and 6) is performed at a first computer system (as described herein) by an application that is different from a system process.

In some embodiments, the instructions of the application, when executed, control the first computer system to perform one or more of processes 500 and 600 (FIGS. 5 and 6) by calling an application programming interface (API) provided by the system process. In some embodiments, the application performs at least a portion of one or more of processes 500 and 600 (FIGS. 5 and 6) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 500 and 600 (FIGS. 5 and 6) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 500 and 600 (FIGS. 5 and 6) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 500 and 600 (FIGS. 5 and 6).

In some embodiments, API 176 defines a first API call response that can be provided to an application by API calling instructions 174, wherein the first API call response includes parameters described above with respect to processes 500 and 600 (FIGS. 5 and 6).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a device interacts with a user. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

What is claimed is:

1. A method, comprising:
at a device, by an application, that is in communication with one or more display generation components:
while a user interface element is being displayed via the one or more display generation components:
receiving an input corresponding to the user interface element; and
in response to receiving the input corresponding to the user interface element:
in accordance with a determination that the input corresponds to a first subject, performing a first operation corresponding to the first subject; and
in accordance with a determination that the input corresponds to a second subject, performing a second operation, different from the first operation, corresponding to the second subject, wherein the second subject is different from the first subject.

2. The method of claim 1, wherein the input corresponding to the user interface element includes an identifier of a respective subject.

3. The method of claim 1, wherein the input corresponding to the user interface element includes an identification of a portion of the user interface element.

4. The method of claim 1, wherein the application is a first application, wherein the user interface element is a first user interface element, wherein the first user interface element corresponds to the first application, the method further comprising:
while displaying the first user interface element, displaying, via the one or more display generation components, a second user interface element different from the first user interface element, wherein the second user interface element corresponds to a second application different from the first application.

5. The method of claim 1, wherein the first operation corresponds to the first subject, and wherein the second operation corresponds to the second subject.

6. The method of claim 5, wherein the first operation is a first type of operation, and wherein the second operation is the first type of operation.

7. The method of claim 1, wherein the input corresponding to the user interface element is received from a system process of the device.

8. The method of claim 7, wherein the user interface element is managed by the system process.

9. The method of claim 1, further comprising:
before receiving the input corresponding to the user interface element, sending, to a system process of the device, a definition of the user interface element.

10. The method of claim 1, wherein:
the device is in communication with one or more cameras;
the determination that the input corresponds to the first subject includes identifying the first subject using content captured via the one or more cameras; and
the determination that the input corresponds to the second subject includes identifying the second subject using the content captured via the one or more cameras.

11. The method of claim 1, wherein the determination that the input corresponds to the first subject is based on receiving a communication from a personal device of the first subject, and wherein the determination that the input corresponds to the second subject is based on receiving a communication from a personal device of the second subject.

12. A non-transitory computer-readable storage medium storing one or more programs configured to be executed by one or more processors of a device, by an application, that is in communication with one or more display generation components, the one or more programs including instructions for:
while a user interface element is being displayed via the one or more display generation components:
receiving an input corresponding to the user interface element; and
in response to receiving the input corresponding to the user interface element:
in accordance with a determination that the input corresponds to a first subject, performing a first operation corresponding to the first subject; and
in accordance with a determination that the input corresponds to a second subject, performing a second operation, different from the first operation, corresponding to the second subject, wherein the second subject is different from the first subject.

13. A device, by an application, configured to communicate with one or more display generation components, the device comprising:
one or more processors; and
memory storing one or more programs configured to be executed by the one or more processors, the one or more programs including instructions for:
while a user interface element is being displayed via the one or more display generation components:
receiving an input corresponding to the user interface element; and
in response to receiving the input corresponding to the user interface element:
in accordance with a determination that the input corresponds to a first subject, performing a first operation corresponding to the first subject; and
in accordance with a determination that the input corresponds to a second subject, performing a second operation, different from the first operation, corresponding to the second subject, wherein the second subject is different from the first subject.
